(19) United States
(12) Patent Application Publication
(10) Pub. No.: US 2018/0059217 A1
(43) Pub. Date: Mar. 1, 2018

(54) METHOD OF REAL-TIME RCS ESTIMATION FOR AN AUTOMOTIVE RADAR OBJECT

(71) Applicant: Jilin University, China, Changchun (CN)

(72) Inventors: Weiwen Deng, Irvine, CA (US); Xin Li, Changchun (CN)

(21) Appl. No.: 15/246,747

(22) Filed: Aug. 25, 2016

(51) Int. Cl. G01S 7/41; G01S 13/93

(52) U.S. Cl. CPC G01S 7/41; G01S 13/931

(57) ABSTRACT

A real-time radar object RCS estimation method includes construction of geometric model of the object and decomposition the object surface into several simple surface elements based on the surface two-dimensional curvature. The method includes decomposition of incident radar wave into two components and ignoring the effect of the tangential component to the RCS computation. Projection area A, reflectivity rate R and direction coefficient D of each simple surface element is computed for calculation of the RCS value of each simple surface element via multiplication of the A, R and D values. The object RCS value is obtained by summing up the RCS values of all simple surface elements.

### FIELD

The present invention relates to intelligent vehicle technology, and more particularly to method of real-time RCS estimation of radar object.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Radar is a device for detection and measurement based on electromagnetic wave. While radar performance is related to the inherent characteristics of the radar, it is also conditioned upon various factors such as object and background environment. Radar Cross Section (RCS) of an object is an important parameter to assess the scattering characteristics of the object; and it is usually defined by the energy strength level of the scattered refection. RCS of an object is mainly related to the various factors of object structure, surface media, radar frequency, form of polarization as well as orientation of the object.

Along with the progress of intelligent vehicles development, radar has become an equipment of intelligent vehicles for object detection and collision avoidance. During the process of automotive radar detection, signal variation of the obstacle object RCS needs to be monitored in real time. The state-of-the-art methods of obtaining object RCS mainly include experimental measurement method and simulation estimation method. Application of the experimental measurement method faces limitation due to the problems of its long cycle and high cost. While the RCS simulation estimation is well supported by classical theories, however, the estimation theories are only applicable to the “far-field” mode, and the method cannot be used for automotive radar object RCS estimation via “direct transplant”. Furthermore, the state-of-the-art estimation theories often utilize the idea of “finite element analysis”, resulting in excessively huge volume of computation for “electrically-large-scale objects”, making the application infeasible for the much needed real-time estimation.

### SUMMARY

A method of real-time Radar Cross Section (RCS) estimation for automotive radar detecting an object in a moving trajectory is disclosed. The method include determination of a static geometric model of the object in the trajectory to generate a surface model of the object. The method also includes decomposition of the surface model into various simple surface elements; and further decomposition of the radar wave into a vertical incident component and a parallel incident component.

The method also includes computation of a projection area (A), a reflectivity rate (R) and a directional coefficient (D) for the simple surface element. The RCS value of each of the simple surface elements is obtained via multiplication of the A, R and D parameters of the respective simple surface element. After all RCS values of the simple surface elements constituting the surface model of the object in its totality are computed, the object RCS value is computed by summing up all the RCS values of the simple surface elements.

Advantageously, the present invention takes a modularized design approach to decompose a radar object into plurality of simple surface elements according to surface curvature of the object, thus greatly reducing the computational load compared with the state-of-the-art technologies;

Advantageously, the present invention provides a feasible method for real-time RCS estimation for vehicle on-board radars; and

Advantageously, the present invention produces RCS estimation results of high accuracy, which has been validated via experiments.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a flow diagram of the real-time RCS estimation method according to the present invention;

FIG. 2 is a depiction of a first driving scenario with embodiment of the method of the present invention in a circular road driving maneuver;

FIG. 3 is an illustration of the comparison of the result of the real-time estimation of the present invention and a state-of-the-art method of non-real-time estimation in the circular road driving scenario;

FIG. 4 is a depiction of a second driving scenario with embodiment of the method of the present invention in an up-hill and down-hill driving maneuver;

FIG. 5 is an illustration of the comparison of the result of the real-time estimation of the present invention and a state-of-the-art method of non-real-time estimation in the up-hill and down-hill driving scenario in the up-hill segment; and

FIG. 6 is an illustration of the comparison of the result of the real-time estimation of the present invention and a state-of-the-art method of non-real-time estimation in the up-hill and down-hill driving scenario in the down-hill segment.

### DETAILED DESCRIPTION

The following description is merely exemplary in nature and is in no way intended to limit the disclosure, its application, or uses. For purposes of clarity, the same reference numbers with or without a single or multiple prime symbols appended thereto will be used in the drawings to identify similar elements.

A method of real-time Radar Cross Section (RCS) estimation is herein disclosed which utilizes a modularized design approach. The radar object is decomposed into plurality of elements based on its surface curvature. Computational load for the process is greatly reduced according to the present invention as compared with the state-of-the-art methods. As a result, real-time RCS estimation of on-board automotive radar is made feasible.

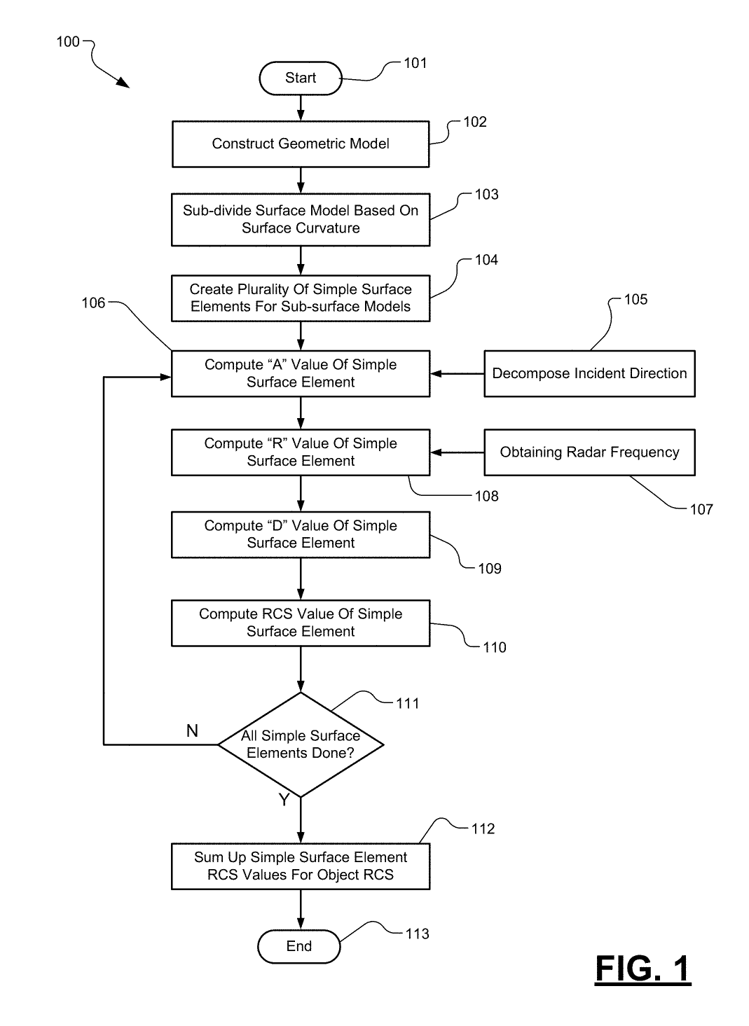

Referring now to FIG. 1, a flow diagram 100 of the real-time RCS estimation method according to the present invention is shown. The flow diagram 100 may start from Step 101 where the RCS estimation method begins.

In Step 102, a static geometric model of the radar object is ascertained over the motion trajectory of the object.

In Step 103, based on the geometric model, the object surface model may be sub-divided into a plurality of sub-surface models based on a characteristic of the two-dimensional surface curvature (or, radii, equivalently) of the object at the various surface locations.

In Step 104, a plurality of simple surface elements is created corresponding to each of the sub-surface models of the object. The simple surface element may be one of a set of pre-selected regular shape surface elements; and the selection of one of the regular shape surface element for creation of the simple surface element may be according to the two-dimensional surface curvature (or radii) of the sub-surface model.

In Step 105, the radar incident wave is decomposed into two components. For each of the simple surface element, radar incident wave may be decomposed into a vertical incident component normal to the simple surface element, and a parallel incident component tangential to the simple surface element. In the computation, the effect of the parallel incident component may be ignored.

In Step 106, the projection area A of each simple surface element may be calculated according to Equation 1 below:

A=x*w (1)

where x represents the length of the projection line of the simple surface element, w represents the width of the projection line of the simple surface element.

In Step 107, the radar frequency is read. Based on the radar frequency, reflectivity rate R of the object is computed according to Equation 2 below in Step 108:

$$R = \frac{1 - \sqrt{r}}{1 + \sqrt{r}} \\ r = \vert ξ - j 60 λμ \vert \qquad ( 2 )$$

where ξ represents dielectric constant of the object material, μ represents the magnetic permeability of the object material, λ represents the radar signal wavelength, and j represent unit of imaginary number. In Equation 2, information of radar signal frequency may be used in lieu of the radar signal wavelength.

In Step 109, a directional coefficient D of each simple surface element is computed. Computation of the directional coefficient is based on selected regular shape surface with shape similar to the decomposed surface sub-area of the object. The regular shape surfaces for selection may include spherical surface, cylinder side surface and flat surface. The directional coefficient of the various regular shape surface is calculated according to Equation 3 below:

$${D}_{i} = \{ \begin{matrix}{D}_{Sphere} = 1 \\ {D}_{CylinderSideSurface ( NormalIncident )} = \frac{π l}{λ} \\ {D}_{CylinderSideSurface ( Non - NormalIncident )} = \frac{π l}{λ} \vert \frac{sin ( \frac{2 π}{λ} l cos θ )}{\frac{2 π}{λ} l cos θ} \vert \\ {D}_{FlatSurface ( NormalIncident )} = \frac{4 π ab}{{λ}^{2}} \\ \begin{matrix}{D}_{FlatSurface ( Non - NormalIncident )} = \frac{4 π ab}{{λ}^{2}} \\ {{[ \frac{sin ( \frac{2 π}{λ} a sin ψcosφ )}{\frac{2 π}{λ} a sin ψcosφ} ]}^{2} [ \frac{sin ( \frac{2 π}{λ} b sin ψsinφ )}{\frac{2 π}{λ} b sin ψsinφ} ]}^{2}\end{matrix}\end{matrix} \qquad ( 3 )$$

where l represents length of cylinder center line, θ represents the angle between the incident radar wave and the cylinder center line, a and b represent the two dimensional sizes of the flat surface, ψ represents the horizontal angle of the incident radar wave to the flat surface, φ represents the angle between the incident radar wave and the normal line of the flat surface.

In Step 110, RCS of each simple surface element is calculated according to Equation 4 below:

RCSᵢ=Aᵢ*Rᵢ*Dᵢ (4)

where A represents projection area, R represents the reflectivity rate, and D represents the directional coefficient of the simple surface element; and i represents the index of the simple surface element under process.

In Step 110, the method 100 determines whether computation of RCS has been performed for all simple surface elements of the object. If all computations are completed, the process is directed to Step 112 where the RCS values of all simple surface elements are summed up for the RCS of the object according to Equation 5 below:

$$RCS = {\sum }_{1}^{K} {RCS}_{i} \qquad ( 5 )$$

where RCSᵢ is the RCS value of each simple surface element, and K represents the total number of simple surface elements decomposed for the object.

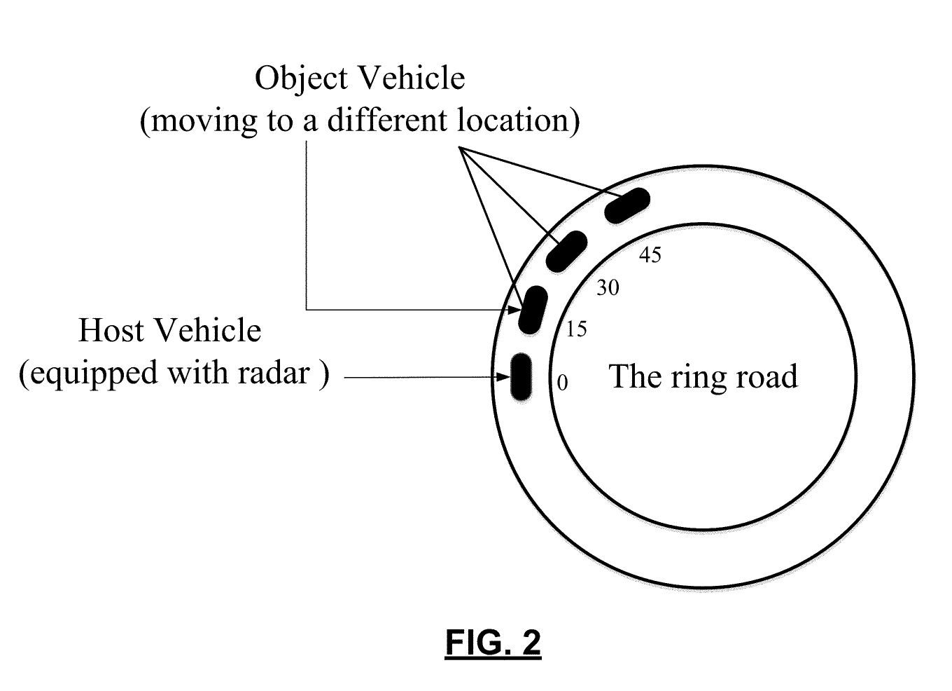

Referring now to FIG. 2, a depiction of a first driving scenario with embodiment of the method of the present invention in a circular road driving maneuver is shown. This driving scenario examines the impact of horizontal angle variation to the RCS estimation according to the present invention.

As depicted in FIG. 2, the host vehicle equipped with radar stays at position of 0 degree on the circular road. The object vehicle starts from the 0-degree position and moves along the circular road to the 45-degree position with a constant speed of 20 km/h. The RCS value is estimated in real time and recorded every 2.5 degree travel of the object vehicle. The result is compared with a non-real-time computation of the object vehicle RCS value based on a state-of-the-art method.

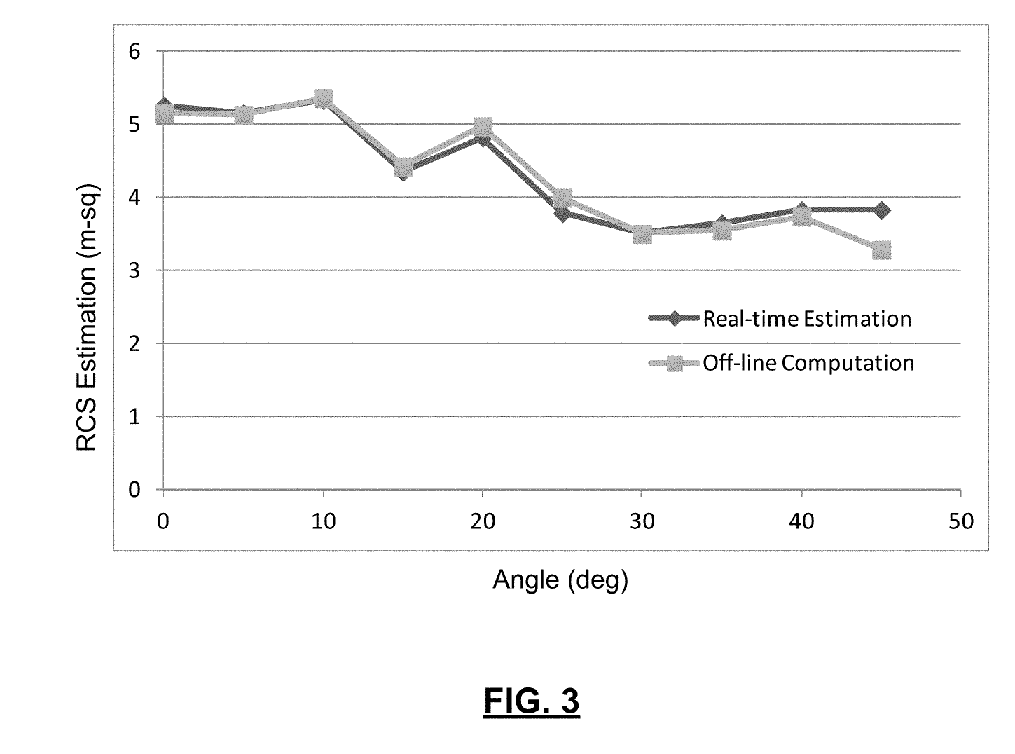

FIG. 3 illustrates a comparison of the result of the real-time estimation of the present invention and a state-of-the-art method of non-real-time (off-line) estimation via extensive computation in the circular road driving scenario. The comparison shows the average absolute deviation from one to the other is 0.132 m², or, equivalently, a percentage difference of 1.618%, proving the accuracy of the method performed in real time according to the present invention.

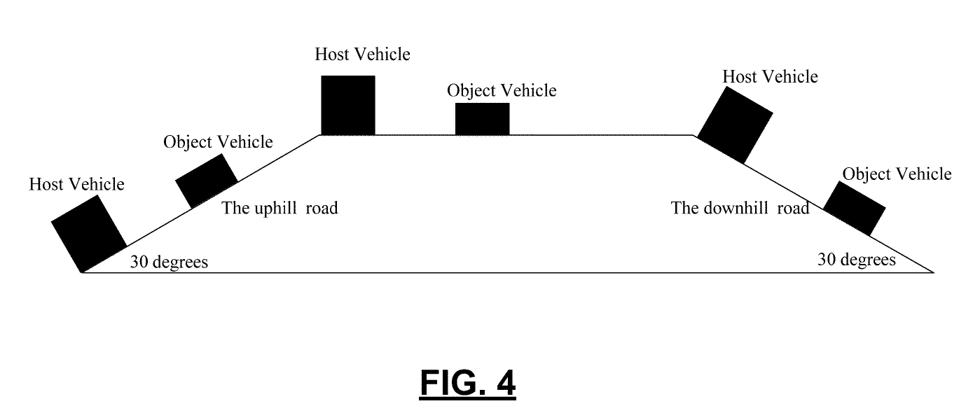

Referring now to FIG. 4, a depiction of a second driving scenario with embodiment of the method of the present invention in an up-hill and down-hill driving maneuver is shown. This driving scenario examines the impact of vertical angle variation to the RCS estimation according to the present invention.

As depicted in FIG. 4, the up-hill segment of the test track is 100-meters long, the slope angle is 30-degrees. The host vehicle equipped with radar stays at the starting position of the lowest point. The object vehicle starts from the starting point and moves uphill with constant speed of 5 m/s. The object vehicle reaches the highest point in 20 seconds. During the up-hill driving process of the object vehicle, the host vehicle performs real-time RCS estimation of the object vehicle and records the values once every 4 seconds.

Also depicted in FIG. 4 is the down-hill segment of the test track with length of 100 meters and a slope angle of 30 degrees. The host vehicle equipped with radar stays at the highest point of the track, and the object vehicle starts from this starting position and moves down-hill with a constant speed of 5 m/s. The object vehicle reaches the lowest position of the track in 20 seconds. During the down-hill driving process of the object vehicle, the host vehicle performs real-time RCS estimation of the object vehicle and records the values once every 4 seconds.

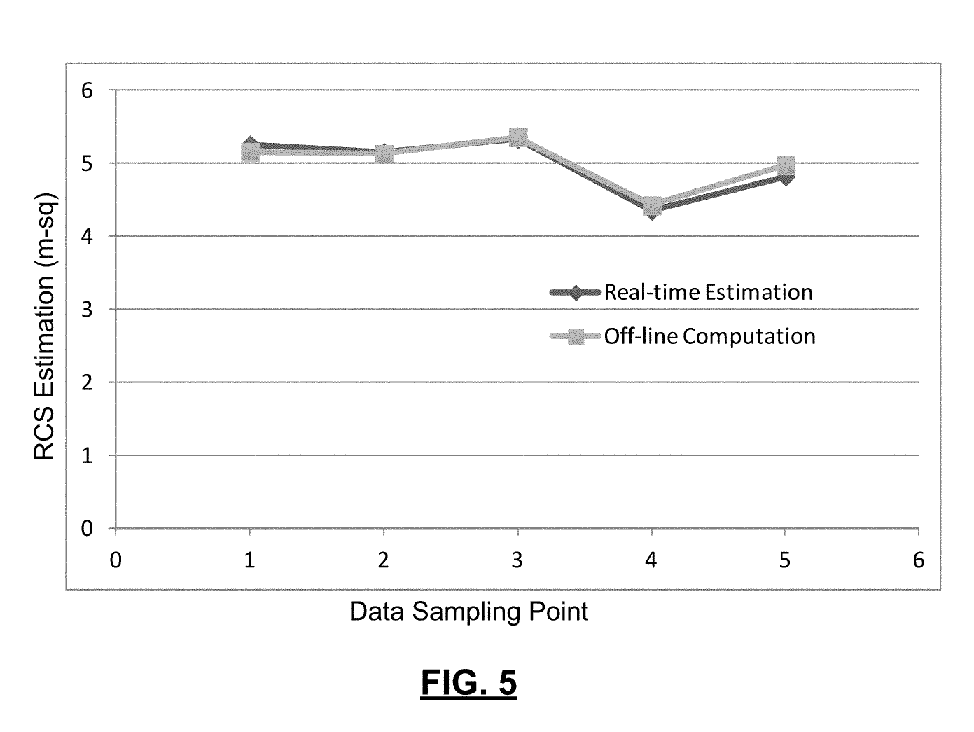

The up-hill test result of the method according to the present invention is compared with a non-real-time computation based on a state-of-the-art method. FIG. 5 illustrates a comparison of the result of the real-time estimation of the present invention and a state-of-the-art method of non-real-time (off-line) estimation via extensive computation in the up-hill and down-hill driving scenario in the up-hill segment. The comparison shows the average absolute deviation from one to the other in this up-hill driving condition is 0.286 m², or, equivalently, a percentage difference of 4.566%, proving the accuracy of the method performed in real time according to the present invention. Likewise, the down-hill test result is compared with a non-real-time computation based on a state-of-the-art method.

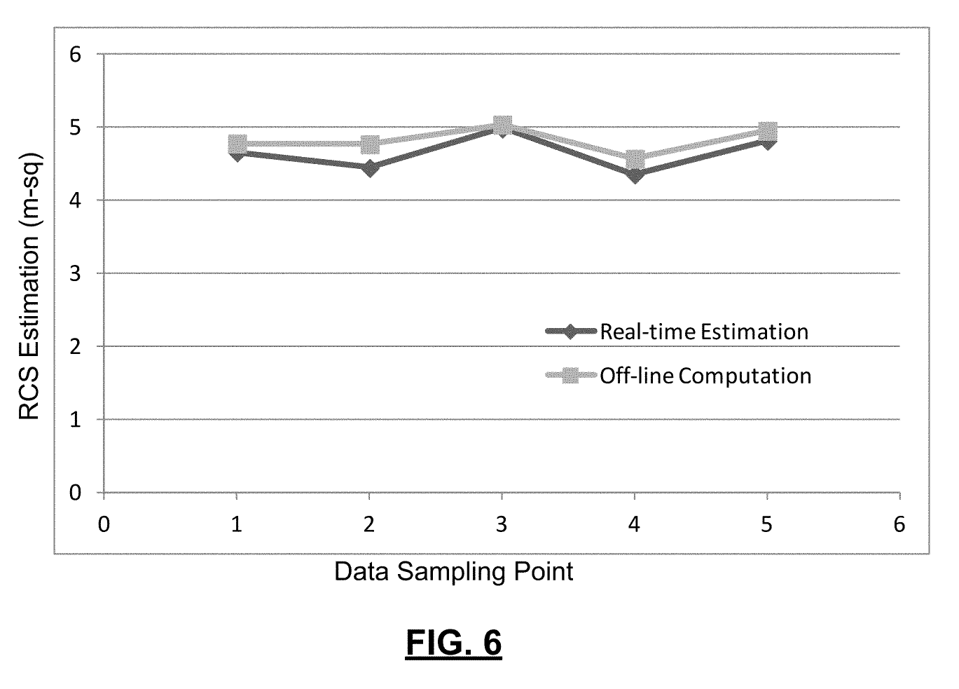

FIG. 6 illustrates a comparison of the result of the real-time estimation of the present invention and a state-of-the-art method of non-real-time (off-line) estimation via extensive computation in the up-hill and down-hill driving scenario in the down-hill segment. The comparison shows the average absolute deviation from one to the other in this down-hill driving condition is 0.172 m², or, equivalently, a percentage difference of 2.572%, proving the accuracy of the method performed in real time according to the present invention.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A method of real-time Radar Cross Section (RCS) estimation for automotive radar transmitting radar wave incident to an object in a moving trajectory comprising steps of:
Constructing a static geometric model of the object in the trajectory wherein the geometric model includes a surface model of the object;
Sub-dividing the surface model into a plurality of sub-surface models;
Creating a plurality of simple surface elements based on each of the corresponding sub-surface models;
Decomposing the radar wave incident to the simple surface element into a vertical incident component and a parallel incident component;
Computing for a first parameter, projection area (A), for the simple surface element according to an equation
A=x*w
where x represents the length of the projection line of the simple surface element, w represents the width of the projection line of the simple surface element;
Computing for a second parameter, object reflectivity rate (R), for the simple surface element according to an equation
$$R = \frac{1 - \sqrt{r}}{1 + \sqrt{r}}$$
$$r = \vert ξ - j 60 λμ \vert$$
where ξ represents dielectric constant of the object material, μ represents the magnetic permeability of the object material, λ represents the radar signal wavelength, and j represent unit of imaginary number;
Computing for a third parameter, directional coefficient (D) of the simple surface element, wherein the directional coefficient (D) is computed based on close similarity of the simple surface element to one of regular shapes comprising spherical surface, cylinder side surface and flat surface, said directional coefficient (D) being computed based on an equation
$${D}_{i} = \{ \begin{matrix}{D}_{Sphere} = 1 \\ {D}_{CylinderSideSurface ( NormalIncident )} = \frac{π l}{λ} \\ {D}_{CylinderSideSurface ( Non - NormalIncident )} = \frac{π l}{λ} \vert \frac{sin ( \frac{2 π}{λ} l cos θ )}{\frac{2 π}{λ} l cos θ} \vert \\ {D}_{FlatSurface ( NormalIncident )} = \frac{4 π ab}{{λ}^{2}} \\ \begin{matrix}{D}_{FlatSurface ( Non - NormalIncident )} = \frac{4 π ab}{{λ}^{2}} \\ {{[ \frac{sin ( \frac{2 π}{λ} a sin ψcosφ )}{\frac{2 π}{λ} a sin ψcosφ} ]}^{2} [ \frac{sin ( \frac{2 π}{λ} b sin ψsinφ )}{\frac{2 π}{λ} b sin ψsinφ} ]}^{2}\end{matrix}\end{matrix}$$
where l represents length of cylinder center line, θ represents the angle between the incident radar wave and the cylinder center line, a and b represent the two dimensional sizes of the flat surface, ψ represents the horizontal angle of the incident radar wave to the flat surface, φ represents the angle between the incident radar wave and the normal line of the flat surface;
Computing for a RCS value of each of the simple surface elements, RCSᵢ, referred by an index i by multiplication of a plurality of the parameters comprising the projection area, the reflectivity rate and the directional coefficient according to an equation
RCSᵢ=Aᵢ*Rᵢ*Dᵢ
where A represents the projection area, R represents the reflectivity rate, and D represents the directional coefficient of the simple surface element; and i represents the index of the simple surface element; and
Computing for a RCS value of the object according to an equation
$$RCS = {\sum }_{1}^{K} {RCS}_{i}$$
where RCSᵢ is the RCS value of each simple surface element, and K represents the total number of simple surface elements decomposed for the object.

2. The method as in claim 1 wherein the step of sub-dividing the surface model into the plurality of sub-surface models is based on a characteristic of two-dimensional surface curvature at each corresponding location of the surface model.

3. The method as in claim 1 further comprising a step of ignoring the effect of the parallel incident component of the radar wave to RCS computation.

4. The method as in claim 1 wherein the RCS value of each of the simple surface element is computed by multiplication of only the three parameters of the projection area (A), the reflectivity rate (R) and the directional coefficient (D).
